(19) United States
(12) Patent Application Publication
(10) Pub. No.: US 2019/0346880 A1
(43) Pub. Date: Nov. 14, 2019

(54) IMAGE FORMING APPARATUS

(71) Applicant: KYOCERA Document Solutions Inc., Osaka (JP)

(72) Inventor: Satoshi ANDO, Osaka-shi (JP)

(73) Assignee: KYOCERA Document Solutions Inc., Osaka (JP)

(21) Appl. No.: 16/402,398

(22) Filed: May 3, 2019

(30) Foreign Application Priority Data
May 9, 2018 (JP) 2018-090590

(51) Int. Cl. G06F 1/16; G03G 15/00; F16M 11/06

(52) U.S. Cl. CPC G06F 1/1601; F16M 11/06; G03G 15/5016

(57) ABSTRACT

An image forming apparatus includes an image forming section, a casing, and a support structure. The image forming section forms an image on paper. The casing houses the image forming section. The support structure supports the operation panel movably from a first position to a second position. The second position is different from the first position. The first position is a position near the casing. The second position is a position away from the first position in a first direction.

### INCORPORATION BY REFERENCE

The present application claims priority under 35 U.S.C. § 119 to Japanese Patent Application No. 2018-090590, filed on May 9, 2018. The contents of this application are incorporated herein by reference in their entirety.

### BACKGROUND

The present disclosure relates to an image forming apparatus.

An image forming apparatus includes an operation panel, a person detection controller, and an operation panel moving section. The person detection controller detects a user in the vicinity of the image forming apparatus. The operation panel moving section changes the orientation of the operation panel. Specifically, the operation panel moving section changes the orientation of the operation panel such that an operation surface of the operation panel is oriented toward the user detected by the person detecting controller.

### SUMMARY

An image forming apparatus according to an aspect of the present disclosure includes an image forming section, a casing, an operation panel, and a support structure. The image forming section forms an image on a recording medium. The casing houses the image forming section. The support structure supports the operation panel movably from a first position to a second position. The second position is different from the first position. The first position is a position near the casing. The second position is a position away from the first position in a first direction.

### BRIEF DESCRIPTION OF THE DRAWINGS

FIG. 1 is a diagram illustrating an example of a configuration of an image forming apparatus according to an embodiment of the present disclosure.

FIG. 2 is a front view of an example of an operation panel in a first position.

FIG. 3 is a side view of the example of the operation panel in the first position.

FIG. 4A is a perspective view of an example of a support structure taken from above.

FIG. 4B is a perspective view of the example of the support structure taken from below.

FIG. 5 is a side view of an example of the operation panel in a second position.

FIG. 6A is a plan view of an example of the support structure.

FIG. 6B is a side view of the example of the support structure.

FIG. 7 is a side view of an example of the operation panel in a third position.

FIG. 8A is a plan view of an example of the support structure.

FIG. 8B is a side view of the example of the support structure.

FIG. 9 is a plan view of an example of a movable range of the operation panel.

### DETAILED DESCRIPTION

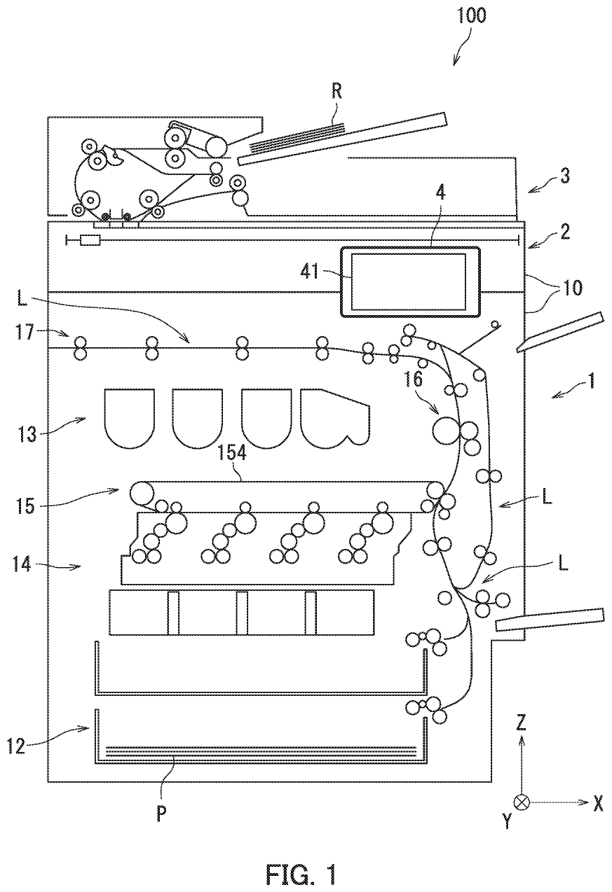

The following describes an embodiment of the present disclosure reference to the accompanying drawings (FIGS. 1 to 9). Note that elements that are the same or equivalent are labelled with the same reference signs in the drawings and description thereof is not repeated.

The following first describes a configuration of an image forming apparatus 100 according to the embodiment of the present disclosure with reference to FIG. 1. FIG. 1 is a diagram illustrating an example of the configuration of the image forming apparatus 100. The image forming apparatus 100 is a color multifunction peripheral.

As illustrated in FIG. 1, the image forming apparatus 100 includes an image forming unit 1, an image reading unit 2, a document conveyance unit 3, an operation panel 4, and a casing 10. The image forming unit 1 forms an image on paper P. The image reading unit 2 reads an image from a document R and generates image information. The document conveyance unit 3 conveys the document R to the image reading unit 2. The operation panel 4 receives user operation.

FIG. 1 shows mutually orthogonal X, Y, and Z axes. The X and Y axes are parallel to a horizontal plane. The Z axis is parallel to a vertical direction. In the following description, a positive Y axial direction may be referred to as backward, and a negative Y axial direction may be referred to as frontward.

The image forming unit 1 includes a feeding section 12, a conveyance section L, a toner supply section 13, an image forming section 14, a fixing section 16, and an ejection section 17. The image forming section 14 includes a transfer section 15. The casing 10 houses the feeding section 12, the conveyance section L, the toner supply section 13, the image forming section 14, the fixing section 16, and the ejection section 17.

The feeding section 12 feeds the paper P to the conveyance section L. The conveyance section L conveys the paper P to the ejection section 17 by way of the transfer section 15 and the fixing section 16.

A toner container is attached to the toner supply section 13. The toner container supplies toner to the image forming section 14. The image forming section 14 forms an image on the paper P.

The transfer section 15 includes an intermediate transfer belt 154. The image forming section 14 transfers cyan, magenta, yellow, and black toner images onto the intermediate transfer belt 154. The multiple colored toner images are superimposed on one another on the intermediate transfer belt 154, thus forming an image on the intermediate transfer belt 154. The transfer section 15 transfers the image from the intermediate transfer belt 154 onto the paper P. As a result, an image is formed on the paper P.

The fixing section 16 applies heat and pressure to the paper P to fix the image formed on the paper P to the paper P. The ejection section 17 ejects the paper P out of the image forming apparatus 100.

The operation panel 4 includes a touch panel 41. The touch panel 41 includes a display and a touch sensor. The display includes for example a liquid-crystal display (LCD) and displays various images. The touch sensor receives operation from a user. The touch sensor is located for example on a display surface of the display.

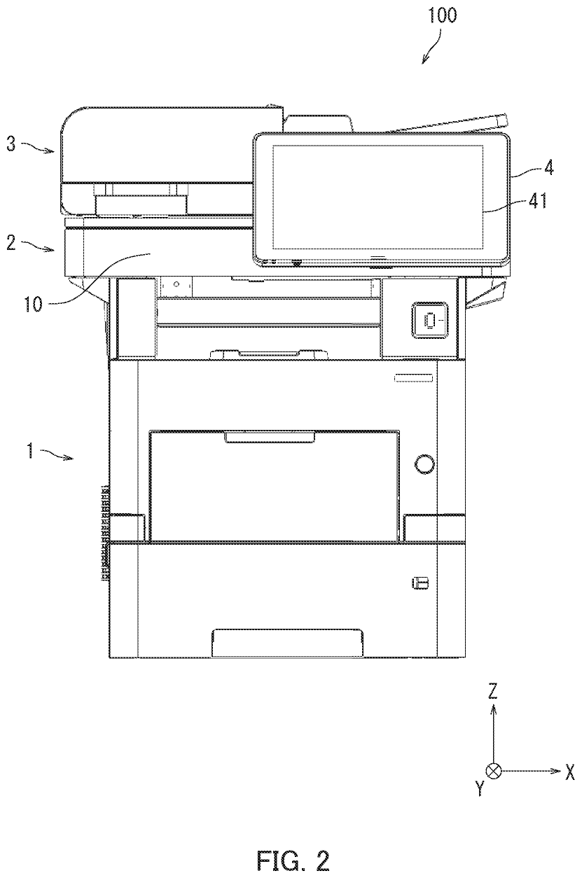

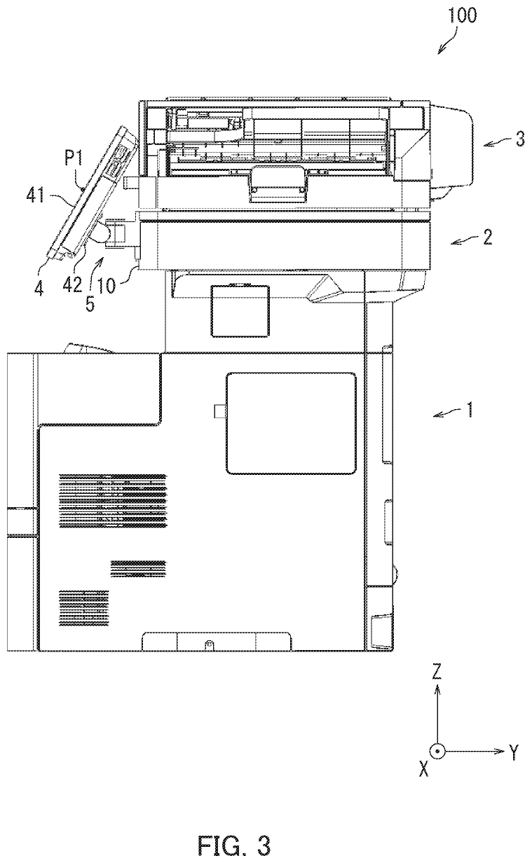

The following describes the operation panel 4 in a first position P1 with reference to FIGS. 1 to 3. The first position P1 is a position near the casing 10. FIG. 2 is a front view of an example of the operation panel 4 in the first position P1. FIG. 3 is a side view of the example of the operation panel 4 in the first position P1.

As illustrated in FIGS. 2 and 3, the operation panel 4 is located near the casing 10. Specifically, the operation panel 4 is located on a negative Y axial side of the casing 10. The touch panel 41 is facing in the negative Y axial direction.

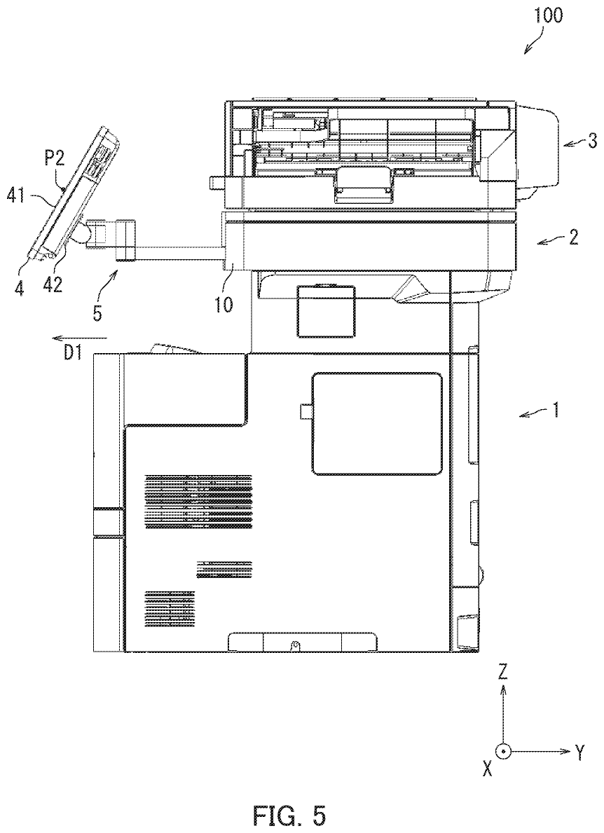

As illustrated in FIG. 3, the image forming apparatus 100 further includes a support structure 5. The support structure 5 supports the operation panel 4. Specifically, the support structure 5 supports the operation panel 4 movably from the first position P1 to a second position P2. The second position P2 is different from the first position P1. The second position P2 is described later in detail with reference to FIG. 5. Accordingly, a user in the vicinity of the first position P1 can easily operate the operation panel 4 when the operation panel 4 is in the first position P1. By contrast, a user in the vicinity of the second position P2 can easily operate the operation panel 4 when the operation panel 4 is in the second position P2. For example, each of a plurality of users can easily operate the operation panel 4 without moving when the image forming apparatus 100 is used by the plurality of users.

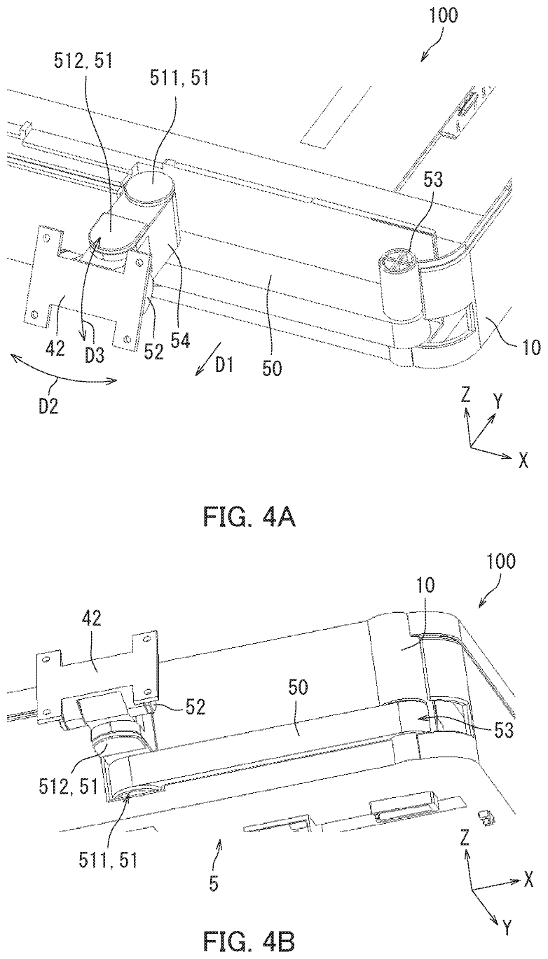

The support structure 5 includes a support member 42. The support member 42 supports the operation panel 4. The support member 42 is on an opposite side of the operation panel 4 from the touch panel 41. The support member 42 is described later in detail with reference to FIGS. 4A and 4B.

The following describes a configuration of the support structure 5 according to the embodiment of the present disclosure with reference to FIGS. 1 to 4B. FIGS. 4A and 4B are perspective views of an example of the support structure 5. Specifically, FIGS. 4A and 4B are perspective views of an example of the support structure 5 in a state in which the operation panel 4 is in the first position P1. FIG. 4A is a perspective view of the example of the support structure 5 taken from above. FIG. 4B is a perspective view of the example of the support structure 5 taken from below.

As illustrated in FIGS. 4A and 4B, the support structure 5 further includes a first arm 50, a first pivoting member 51, a second pivoting member 52, a third pivoting member 53, and a second arm 54.

The first arm 50 supports the operation panel 4. The first arm 50 extends for example along the X axis in FIGS. 4A and 4B. One end of the first arm 50 supports the operation panel 4. The one end of the first arm 50 is a negative X axial end of the first arm 50 in FIGS. 4A and 4B. Another end of the first arm 50 is supported by the casing 10. The other end of the first arm 50 is a positive X axial end of the first arm 50 in FIGS. 4A and 4B. The first arm 50 is equivalent to an example of an “arm”.

The first pivoting member 51 supports the operation panel 4 while allowing the orientation of the operation panel 4 to be changed in a left-right direction D2. The orientation of the operation panel 4 is the orientation of the touch panel 41. The left-right direction D2 is negative and positive X axial directions. For example, in FIG. 4A, the left-right direction D2 is a rotational direction about a rotational axis that is parallel to the Z axis, and includes a clockwise direction and a counter clockwise direction as viewed in a negative Z axial direction. The first pivoting member 51 includes a first pivoting member 511 and a first pivoting member 512. The first pivoting member 511 is located on the one end of the first arm 50. That is, the one end of the first arm 50 supports the operation panel 4 through the first pivoting member 511.

The second arm 54 supports the operation panel 4. The second arm 54 extends for example along the Y axis in FIGS. 4A and 4B. One end of the second arm 54 supports the operation panel 4. The one end of the second arm 54 is a negative Y axial end of the second arm 54 in FIGS. 4A and 4B. Another end of the second arm 54 is pivotably supported by the first arm 50. The other end of the second arm 54 is a positive Y axial end of the second arm 54 in FIGS. 4A and 4B. The first pivoting member 511 supports the second arm 54 while allowing the second arm to pivot with respect to the first arm 50.

The first pivoting member 512 supports the operation panel 4 while allowing the orientation of the operation panel 4 to be changed in the left-right direction D2. The first pivoting member 512 is located on the one end of the second arm 54. The one end of the second arm 54 is the negative Y axial end of the second arm 54 in FIGS. 4A and 4B. The first pivoting member 512 supports the second pivoting member 52 while allowing the second pivoting member 52 to pivot with respect to the second arm 54. That is, the first pivoting member 512 supports the operation panel 4 through the second pivoting member 52.

The second pivoting member 52 supports the operation panel 4 while allowing the orientation of the operation panel 4 to be changed in an up-and-down direction D3. The up-and-down direction D3 is negative and positive Z axial directions. For example, the up-and-down direction D3 is a rotational direction about a rotational axis that is parallel to the X axis, and includes a clockwise direction and a counter clockwise direction as viewed in the negative X axial direction in FIG. 4A. The second pivoting member 52 is supported by the first pivoting member 512. The second pivoting member 52 supports the support member 42 while allowing the support member 42 to pivot with respect to the first pivoting member 512.

The third pivoting member 53 pivotably supports the first arm 50. The third pivoting member 53 is fixed to the casing 10. Specifically, the third pivoting member 53 is fixed to an end portion on a positive X axial side and the negative Y axial side of the casing 10. The third pivoting member 53 supports the first arm 50 while allowing the first arm 50 to pivot with respect to the casing 10. For example, the first arm 50 rotates, with respect to the casing 10, about a rotational axis that is parallel to the Z axis. The third pivoting member 53 protrudes from the casing 10 in the negative Y axial direction.

According to the embodiment of the present disclosure as described above with reference to FIGS. 1 to 4B, the one end of the first arm 50 supports the operation panel 4 through the first pivoting member 51, and the first pivoting member 51 supports the operation panel 4 while allowing the orientation of the operation panel 4 to be changed in the left-right direction D2. Therefore, a user can change the orientation of the operation panel 4 to a desired orientation in the left-right direction D2. Accordingly, the user can easily operate the operation panel 4.

The second pivoting member 52 supports the operation panel 4 while allowing the orientation of the operation panel 4 to be changed in an up-and-down direction D3. Therefore, the user can change the orientation of the operation panel 4 to a desired orientation in the up-and-down direction D3. Accordingly, the user can more easily operate the operation panel 4.

The third pivoting member 53 pivotably supports the first arm 50. Therefore, the first arm 50 can rotate with respect to the casing 10. Accordingly, a user in the vicinity of a position separated from the third pivoting member 53 by the length of the first arm 50 in the negative Y axial direction with respect to the casing 10 can easily operate the operation panel 4.

The third pivoting member 53 protrudes from the casing 10 in the negative Y axial direction. Therefore, the rotatable angle of the first arm 50 is large. This arrangement can accordingly expand the range of a user position where the user can operate the operation panel 4.

Note that although the support structure 5 includes the first pivoting member 511 and the first pivoting member 512 according to the embodiment of the present disclosure, the present disclosure is not limited as such. The support structure 5 may include only one of the first pivoting member 511 and the first pivoting member 512.

The following describes the operation panel 4 in the second position P2 with reference to FIGS. 2 to 6B. FIG. 5 is a side view of an example of the operation panel 4 in the second position P2.

As illustrated in FIG. 5, the second position P2 is a position away from the first position P1 illustrated in FIG. 3 in a first direction D1. The first direction D1 is the negative Y axial direction. The operation panel 4 moves from the first position P1 to the second position P2 due to the user pulling the operation panel 4 in the first direction D1.

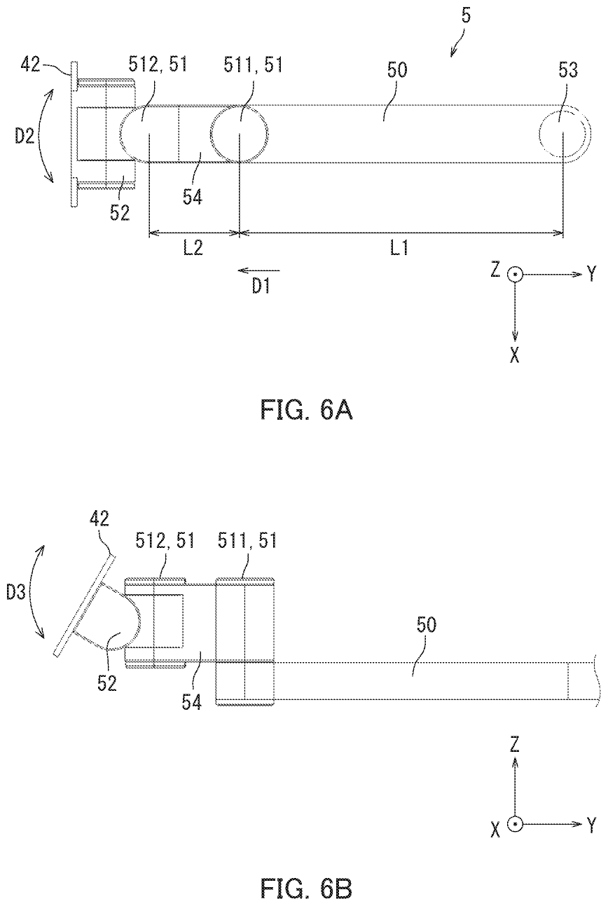

FIGS. 6A and 6B are diagrams illustrating an example of the support structure 5 in a state in which the operation panel 4 is in the second position P2. FIG. 6A is a plan view of the example of the support structure 5. FIG. 6B is a side view of the example of the support structure 5.

As illustrated in FIGS. 6A and 6B, the first arm 50 and the second arm 54 extend in the first direction D1. The support structure 5 is moved as described below as the operation panel 4 moves from the first position P1 to the second position P2.

The third pivoting member 53 allows the first arm 50 to rotate such that the first arm 50 extends in the first direction D1. That is, the first arm 50 is rotated by 90 degrees clockwise from the state illustrated in FIG. 4 when viewed in plan.

The first pivoting member 511 allows the second arm 54 to rotate such that the second arm 54 extends in the first direction D1. That is, the second arm 54 is rotated by 90 degrees counter clockwise from the state illustrated in FIG. 4 when viewed in plan.

The operation panel 4 moves in the first direction D1 by a distance L3 as the operation panel 4 moves from the first position P1 to the second position P2. The distance L3 is defined by the following formula (1). A distance L1 is the length of the first arm 50. A distance L2 is the length of the second arm 54.

L3=L1+L2 (1)

The first pivoting member 512 supports the second pivoting member 52 while allowing the second pivoting member to pivot with respect to the second arm 54 in the left-right direction D2. The second pivoting member 52 supports the operation panel 4 while allowing the orientation of the operation panel 4 to be changed in the up-and-down direction D3.

According to the embodiment of the present disclosure as described above with reference to FIGS. 2 to 6B, the support structure 5 supports the operation panel 4 movably from the first position P1 to the second position P2. The first position P1 is a position near the casing 10. The second position P2 is a position away from the first position P1 in the first direction D1. Therefore, the user in the vicinity of the second position P2 can operate the operation panel 4. Accordingly, a user in a position away from the image forming apparatus 100 can operate the operation panel 4.

The one end of the first arm 50 supports the operation panel 4, and the other end of the first arm 50 is supported by the casing 10. Therefore, the operation panel 4 can be moved from the first position P1 to the second position P2 in a simple configuration. Accordingly, the user in the vicinity of the second position P2 can operate the operation panel 4.

The first pivoting member 512 supports the operation panel 4 while allowing the orientation of the operation panel 4 to be changed in the left-right direction D2. Therefore, the user can change the orientation of the operation panel 4 to a desired orientation in the left-right direction D2 in a state in which the operation panel 4 is in the second position P2. Accordingly, the user in the vicinity of the second position P2 can easily operate the operation panel 4.

The second pivoting member 52 supports the operation panel 4 while allowing the orientation of the operation panel 4 to be changed in the up-and-down direction D3. Therefore, the user can change the orientation of the operation panel 4 to a desired orientation in the up-and-down direction D3 in a state in which the operation panel 4 is in the second position P2. Accordingly, the user in the vicinity of the second position P2 can more easily operate the operation panel 4.

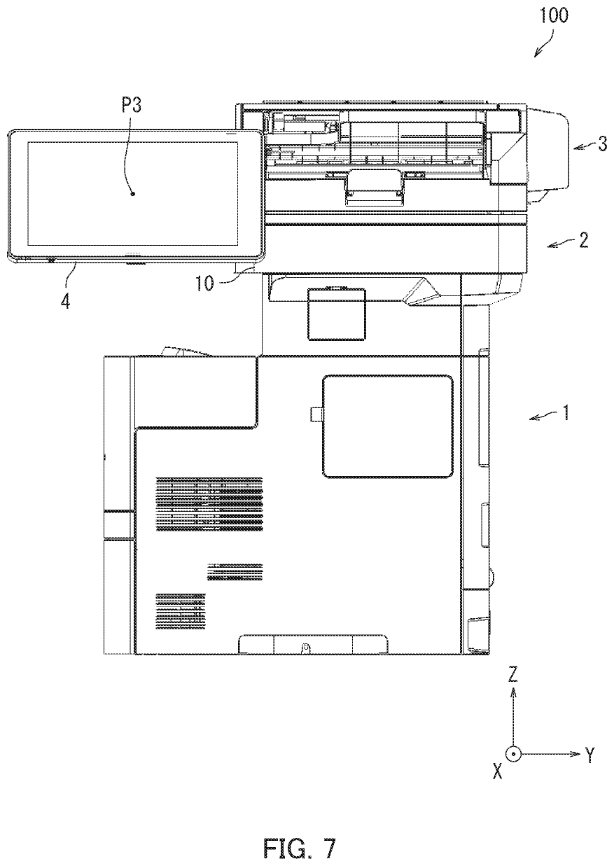

The following describes the operation panel 4 in a third position P3 with reference to FIGS. 2 to 8B. FIG. 7 is a side view of an example of the operation panel 4 in the third position P3.

As illustrated in FIG. 7, the third position P3 is a position away from the first position P1 illustrated in FIG. 3 in the first direction D1. The operation panel 4 moves from the first position P1 to the third position P3 by way of the second position P2 by being pulled in the first direction D1 (negative Y axial direction) and being additionally rotated in the positive X axial direction.

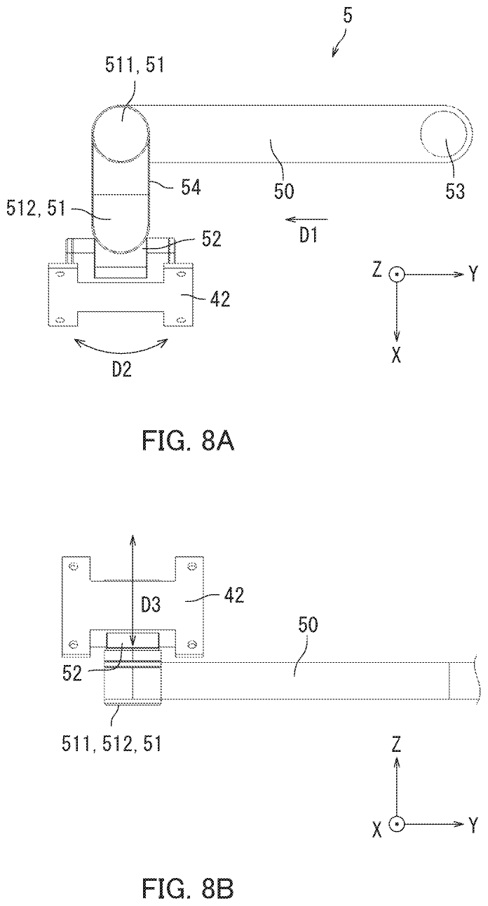

FIGS. 8A and 8B are diagrams illustrating an example of the support structure 5 in a state in which the operation panel 4 is in the third position P3. FIG. 8A is a plan view of the example of the support structure 5. FIG. 8B is a side view of the example of the support structure 5.

As illustrated in FIGS. 8A and 8B, the first arm 50 extends in the first direction D1. The second arm 54 extends along the X axis. Specifically, the second arm 54 is rotated clockwise with respect to the first arm 50 in the first pivoting member 511 when viewed in plan such that the operation panel 4 is oriented in the positive X axial direction. The support structure 5 is moved as described below as the operation panel 4 moves from the second position P2 illustrated in FIGS. 5, 6A, and 6B to the third position P3.

The first pivoting member 511 allows the second arm 54 to rotate so as to extend along the X axis. That is, the second arm 54 is rotated by 90 degrees clockwise from the state illustrated in FIG. 6A when viewed in plan.

The operation panel 4 is oriented in the positive X axial direction as the operation panel 4 moves from the second position P2 to the third position P3.

The first pivoting member 512 supports the second pivoting member 52 while allowing the second pivoting member 52 to pivot in the left-right direction D2 with respect to the second arm 54. In the state in which the operation panel 4 is in the third position P3, the left-right direction D2 is the positive and negative Y axial directions as illustrated in FIG. 8A. In FIG. 8A for example, the left-right direction D2 is a rotational direction about a rotational axis parallel to the Z axis, and includes a clockwise direction and a counter clockwise direction when viewed in the negative Z axial direction. The second pivoting member 52 supports the operation panel 4 while allowing the orientation of the operation panel 4 to be changed in the up-and-down direction D3. In FIG. 8B for example, the up-and-down direction D3 is a rotational direction about a rotational axis that is parallel to the Y axis, and includes a clockwise direction and a counter clockwise direction as viewed in the negative Y axial direction.

According to the embodiment of the present disclosure as described above with reference to FIGS. 2 to 8B, the support structure 5 supports the operation panel 4 movably from the second position P2 to the third position P3. The second position P2 is a position away from the first position P1 in the first direction D1. The third position P3 is a position away from the second position P2 in the positive X axial direction. Therefore, a user in the vicinity of the third position P3 can operate the operation panel 4. Accordingly, a user in a position away from the image forming apparatus 100 can operate the operation panel 4.

The one end of the second arm 54 supports the operation panel 4, and the other end of the second arm 54 is supported by the first arm 50. Accordingly, the operation panel 4 can be moved from the second position P2 to the third position P3 in a simple configuration.

The first pivoting member 512 supports the operation panel 4 while allowing the orientation of the operation panel 4 to be changed in the left-right direction D2. Therefore, the user can change the orientation of the operation panel 4 to a desired orientation in the left-right direction D2 in a state in which the operation panel 4 is in the third position P3. Accordingly, the user in the vicinity of the second position P2 can easily operate the operation panel 4.

The second pivoting member 52 supports the operation panel 4 while allowing the orientation of the operation panel 4 to be changed in the up-and-down direction D3. Therefore, the user can change the orientation of the operation panel 4 to a desired orientation in the up-and-down direction D3 in the state in which the operation panel 4 is in the third position P3. Accordingly, the user in the vicinity of the second position P2 can more easily operate the operation panel 4.

Note that although the second arm 54 moves by 90 degrees clockwise from the state illustrated in FIG. 6A when viewed in plan according to the embodiment of the present disclosure, the present disclosure is not limited as such. The second arm 54 may be moved by 90 degrees counter clockwise from the state illustrated in FIG. 6A. In this case, the operation panel 4 can be moved from the second position P2 to a fourth position P4. The fourth position P4 is in the negative X axial direction with respect to the second position P2.

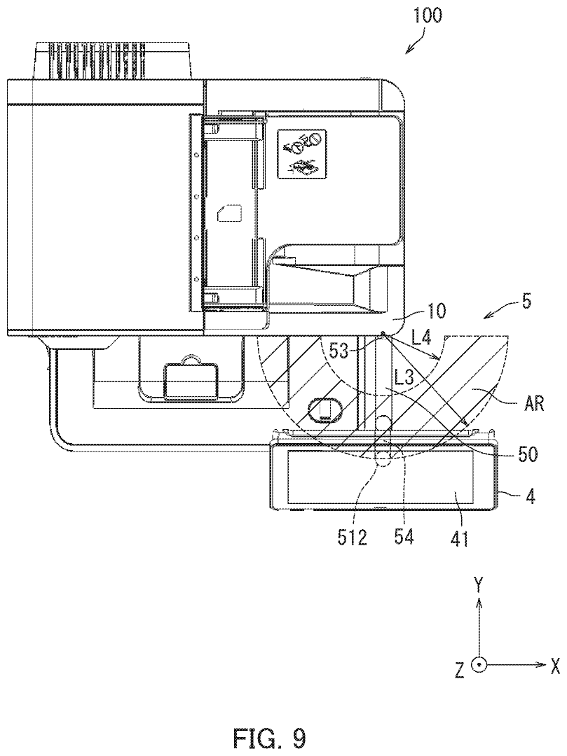

The following describes a movement range AR of the operation panel 4 with reference to FIGS. 2 to 9. FIG. 9 is a plan view of an example of the movement range AR of the operation panel 4. The movement range AR of the first pivoting member 512 is illustrated in FIG. 9.

As illustrated in FIG. 9, an outer periphery of the movement range AR is a semicircle with a radius equal to the distance L3. The center of the semicircle is the center of rotation of the third pivoting member 53. An inner periphery of the movement range AR is a semicircle with a radius equal to a distance L4. The distance L4 is defined by the following formula (2).

L4=L1−L2 (2)

That is, the outer periphery of the movement range AR indicates a track of the first pivoting member 512 when the second arm 54 extends in the same direction as the first arm 50. The inner periphery of the movement range AR indicates the track of the first pivoting member 512 when the second arm 54 extends in the opposite direction as the first arm 50.

According to the embodiment of the present disclosure as illustrated in FIGS. 2 to 9, the movement range AR of the operation panel 4 can be increased as a length L1 of the first arm 50 increases. The movement range AR of the operation panel 4 can also be increased as a length L2 of the second arm 54 increases.

The radius of the semicircle indicating the inner periphery of the movement range AR can be decreased as the difference between the length L1 of the first arm 50 and the length L2 of the second arm 54 decreases. That is, an area in which the first pivoting member 512 cannot move can be decreased.

The embodiment of the present disclosure is described above with reference to the drawings. However, the present disclosure is not limited to the above embodiment, and may be implemented in various manners within a scope not departing from the gist of the present disclosure (for example, as described below in (1) and (2)). The drawings schematically illustrate main elements of configuration to facilitate understanding thereof. Aspects of the elements of configuration such as thickness, length, and number thereof illustrated in the drawings may differ in practice for the sake of convenience for drawing preparation. Furthermore, aspects of the elements of configuration such as shape and dimension thereof described in the above embodiment are merely examples and are not particularly limited. The elements of configuration may be variously altered within a scope not substantially departing from the configuration of the present disclosure.

(1) According to the embodiment of the present disclosure as described with reference to FIG. 1, the image forming apparatus 100 is a color multifunction peripheral. However, the present disclosure is not limited as such. The image forming apparatus 100 need only form an image on the paper P. The image forming apparatus 100 may be a color printer, for example. The image forming apparatus 100 may alternatively be a monochrome copier, for example.

(2) According to the embodiment of the present disclosure as described with reference to FIG. 5, the first direction D1 is the negative Y axial direction. However, the present disclosure is not limited as such. The first direction D1 may be any direction. For example, the first direction D1 may be the positive Y axial direction. For another example, the first direction D1 may be the positive or negative X axial directions. For yet another example, the first direction D1 may be the positive or negative Z axial directions.

What is claimed is:

1. An image forming apparatus comprising:
an image forming section configured to form an image on a recording medium;
a casing housing the image forming section;
an operation panel; and
a support structure supporting the operation panel movably from a first position to a second position, the second position being different from the first position, wherein
the first position is a position near the casing, and
the second position is a position away from the first position in a first direction.

2. The image forming apparatus according to claim 1, wherein
the support structure includes an arm which supports the operation panel,
one end of the arm supports the operation panel, and
another end of the arm is supported by the casing.

3. The image forming apparatus according to claim 2, wherein
the support structure further includes a first pivoting member supporting the operation panel while allowing orientation of the operation panel to be changed in a left-right direction, and
the one end of the arm supports the operation panel through the first pivoting member.

4. The image forming apparatus according to claim 3, wherein
the support structure further includes a second pivoting member configured to support the operation panel while allowing orientation of the operation panel to be changed in an up-and-down direction, and
the first pivoting member supports the operation panel through the second pivoting member.

5. The image forming apparatus according to claim 2, wherein
the support structure further includes a third pivoting member pivotably supporting the arm, and
the third pivoting member is fixed to the casing.

6. The image forming apparatus according to claim 5, wherein
the third pivoting member protrudes from the casing in the first direction.
